(19) United States
(12) Patent Application Publication
(10) Pub. No.: US 2026/0300167 A1
(43) Pub. Date: Oct. 1, 2026

(54) MULTI-TABLE DISTRIBUTION ENCODING

(71) Applicant: Microsoft Technology Licensing, LLC, Redmond, WA (US)

(72) Inventors: Robert Peter GMYR, Kirkland, WA (US); Ashraf Ayman MICHAIL, Kirkland, WA (US)

(73) Assignee: Microsoft Technology Licensing, LLC, Redmond, WA (US)

(21) Appl. No.: 19/094,382

(22) Filed: Mar. 28, 2025

(51) Int. Cl. G06F 12/02

(52) U.S. Cl. CPC G06F 12/0292; G06F 2212/651

(57) ABSTRACT

A computing system including memory storing encoded sub-blocks of an encoded matrix block. Each of the encoded sub-blocks includes element indices. The memory further stores lookup tables that each include centroid values. The memory further stores a table index array including table indices that specify lookup tables associated with the encoded sub-blocks. The computing system further includes one or more processing devices configured to, for each of the encoded sub-blocks, retrieve the table index, retrieve the lookup table specified by the table index, and retrieve the element indices included in the encoded sub-block. The one or more processing devices perform table lookup operations using the table index, lookup table, and element indices to compute a decoded sub-block that includes, for each of the element indices, the corresponding centroid value specified by that element index. The one or more processing devices output a decoded matrix block including the decoded sub-blocks.

### BACKGROUND

Machine learning (ML) model inferencing is often computationally expensive in terms of computational resources such as memory bandwidth, storage space, processing time, and energy consumption. These computational costs are especially high for ML models that include large numbers of parameters, such as large language models (LLMs) and large multimodal models (LMMs).

In order to reduce resource consumption during ML model inferencing, quantization is frequently applied to ML model parameters. When the parameters of an ML model are quantized, those parameters are compressed to have smaller sizes in memory. For example, parameters in the 16-bit floating-point (FP16) format may be compressed to instead have an 8-bit floating-point (FP8) format or a 6-bit floating-point (FP6) format. In addition to the ML model parameters, the activations computed at an ML model are sometimes also quantized. Quantization is also performed during ML model training as well as inferencing in some examples. Quantizing the ML model weights and/or activations reduces the amounts of computational resources consumed during ML model inferencing or training, with the potential drawback of reduced model accuracy.

### SUMMARY

According to one aspect of the present disclosure, a computing system is provided, including memory storing a plurality of encoded sub-blocks of an encoded matrix block. Each of the encoded sub-blocks includes a plurality of element indices. The memory further stores a plurality of lookup tables that each include a respective plurality of centroid values. The memory further stores a table index array including a plurality of table indices that specify respective lookup tables associated with the encoded sub-blocks. The computing system further includes one or more processing devices configured to, during a decoding stage, for each of the encoded sub-blocks, retrieve the table index of the encoded sub-block. For each of the encoded sub-blocks, the one or more processing devices are further configured to retrieve the lookup table specified by the table index of the encoded sub-block. For each of the encoded sub-blocks, the one or more processing devices are further configured to retrieve the element indices included in the encoded sub-block. For each of the encoded sub-blocks, the one or more processing devices are further configured to perform a plurality of table lookup operations using the table index, the lookup table, and the element indices to compute a decoded sub-block that includes, for each of the element indices included in the encoded sub-block, the corresponding centroid value specified by that element index. The one or more processing devices are further configured to output a decoded matrix block including the decoded sub-blocks computed from each of the encoded sub-blocks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1B schematically show an example of distribution encoding performed according to a conventional approach.

FIG. 2 schematically depicts a computing system at which one or more processing devices are configured to perform multi-table distribution encoding, according to one example embodiment.

FIG. 3 schematically shows an encoded matrix block, a first lookup table, a second lookup table, and a table index array, according to the example of FIG. 2.

FIG. 4A schematically shows the computing system when the one or more processing devices are configured to perform an encoding stage including a plurality of block encoding iterations, according to the example of FIG. 2.

FIG. 4B schematically shows the computing system when the one or more processing devices are configured to perform a table sampling stage included in a block encoding iteration, according to the example of FIG. 4A.

FIG. 5 schematically shows the computing system when the one or more processing devices are configured to perform a decoding stage, according to the example of FIG. 2.

FIG. 6A shows a flowchart of a method for use with a computing system to decode an encoded matrix block, according to the example of FIG. 2.

FIGS. 6B-6D shows additional steps of the method of FIG. 6A that may be performed during an encoding stage to compute the encoded matrix block.

FIG. 7 shows a schematic view of an example computing environment in which the computing system of FIG. 2 may be instantiated.

### DETAILED DESCRIPTION

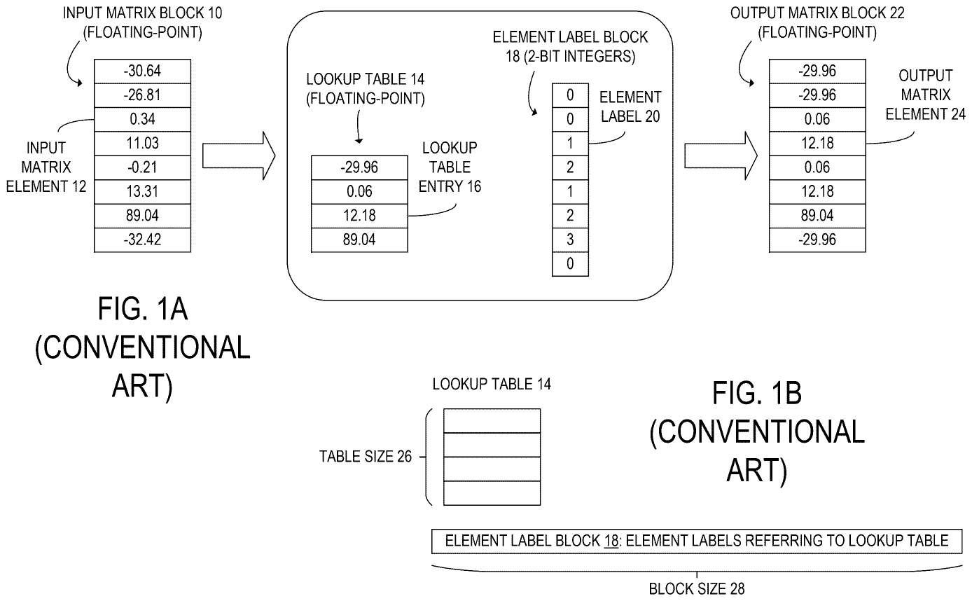

Distribution encoding is an existing technique that has been used to perform quantization on ML model weights and activations. FIGS. 1A-1B show an example of distribution encoding. When distribution encoding is performed, as shown in FIG. 1A, a matrix of weights or activations is divided into a plurality of input matrix blocks 10. Each of the input matrix blocks 10 includes a plurality of input matrix elements 12, which are floating-point numbers in the example of FIG. 1A.

Distribution encoding further includes computing a lookup table 14 associated with the input matrix block 10. The lookup table 14 includes a plurality of lookup table entries 16 that have the floating-point format and that approximate different portions of the range of values taken by the input matrix elements 12. For example, the lookup table entries 16 may be computed by executing a clustering algorithm over the input matrix elements 12. In this example, the lookup table 14 includes four lookup table entries 16 that correspond to four clusters computed for the input matrix block 10.

Distribution encoding further includes computing an element label block 18 including a plurality of element labels 20. The element labels 20, in the example of FIG. 1A, are 2-bit integers that each specify a respective index in the lookup table 14. The element label block 18 therefore indicate, for each of the input matrix elements 12, the cluster to which that input matrix element 12 belongs. The element label block 18 is used as a compressed version of the input matrix block 10. Since the element labels 20 are represented with fewer bits than the input matrix elements, the element label block 18 has a smaller storage size than the input matrix block 10 and occupies less memory bandwidth.

In the example of FIG. 1A, the lookup table 14 and the element label block 18 are decoded to obtain an output matrix block 22 that includes a plurality of output matrix elements 24. This decoding is performed by mapping the element labels 20 included in the element label block 18 to the lookup table entries 16 located at the indices within the lookup table 14 specified by those element labels 20. Those lookup table entries 16 are inserted into the output matrix block 22 at the positions of the corresponding element labels 20. Thus, the output matrix block 22 is computed as an approximation of the input matrix block 10.

As shown in FIG. 1B, distribution encoding has two parameters: a table size 26 that specifies the number of lookup table entries 16 in the lookup table 14, and a block size 28 that specifies the number of input matrix elements 12 included in the input matrix block 10. The block size 28 is also equal to the number of element labels 20 included in the element label block 18 and the number of output matrix elements 24 included in the output matrix block 22.

As shown in FIG. 1A, distribution encoding approximates the input matrix elements 12 with the lookup table entries 16 computed as approximations of input matrix element clusters. This approximation results in quantization error, since the output matrix elements 24 have values that differ from those of the input matrix elements 12. Accordingly, using distribution encoding on the weights and/or activations of an ML model may reduce the accuracy of the model's outputs.

In order to address the shortcomings of existing approaches to distribution encoding, a multi-table distribution encoding approach is provided herein. In multi-table distribution encoding, lookup table entries stored in a plurality of lookup tables are used to approximate the matrix elements of an input matrix block. In addition, one or more of the lookup tables are shared by two or more sub-blocks. Using multiple lookup tables in distribution encoding allows quantization error to be reduced while also avoiding the high overhead associated with using a unique lookup table for each sub-block.

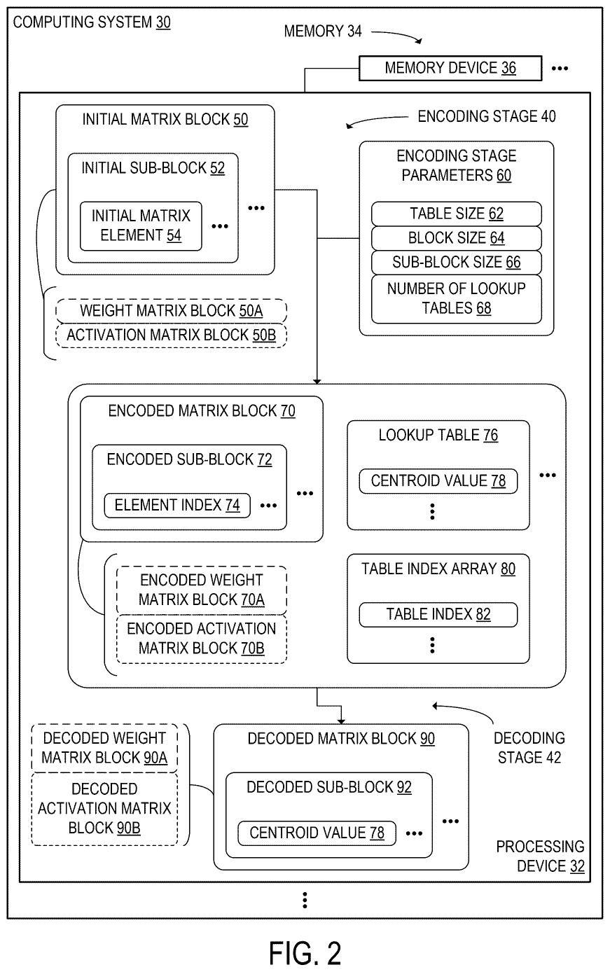

FIG. 2 schematically depicts a computing system 30 at which multi-table distribution encoding is performed. The computing system 30 includes one or more processing devices 32, along with memory 34 that includes one or more memory devices 36. The one or more processing devices 32 may, for example, include one or more central processing units (CPUs), one or more graphics processing units (GPUs), one or more neural processing units (NPUs), and/or one or more other types of processing devices. The memory 34 may include, as the one or more memory devices 36, one or more volatile memory devices and one or more non-volatile storage devices. The one or more memory devices 36 may, in some examples, include closely coupled memory of the one or more processing devices 32. As discussed in further detail below, the computing processes discussed herein may be efficiently implemented using a GPU and the closely coupled memory of the GPU.

FIG. 2 schematically shows the computing system 30 when the one or more processing devices 32 are configured to perform an encoding stage 40 and a decoding stage 42 to encode and decode an encoded matrix block 70. During the encoding stage 40, the one or more processing devices 32 are configured to receive an initial matrix block 50 of an initial matrix. For example, the initial matrix may be a weight matrix block 50A or an activation matrix block 50B included in a corresponding weight matrix or activation matrix of a neural network. The initial matrix block 50 includes a plurality of initial sub-blocks 52, which each in turn include a plurality of initial matrix elements 54.

During the encoding stage 40, the one or more processing devices 32 are further configured to receive a plurality of encoding stage parameters 60. The encoding stage parameters 60 may include a table size 62 of each of a plurality of lookup tables 76. The encoding stage parameters 60 may further include a block size 64 of the initial matrix block 50 and a sub-block size 66 of the initial sub-blocks 52. The block size 64 is divisible by the sub-block size 66. The encoding stage parameters 60 may further include a number of lookup tables 68 computed for the encoded matrix block 70. The one or more processing devices are configured to perform the encoding stage 40 with the lookup tables 76, the initial matrix block 50, and the initial sub-blocks 52 parameterized according to the encoding stage parameters 60.

During the encoding stage 40, the one or more processing devices 32 are configured to compute an encoded matrix block 70 that includes a plurality of encoded sub-blocks 72. The encoded matrix block 70 may be a portion of a larger encoded matrix. For example, the encoded matrix block 70 may be an encoded weight matrix block 70A or an encoded activation matrix block 70B of a neural network, and may accordingly be included in a weight matrix or an activation matrix. Alternatively, the encoded matrix block 70 may be an encoded block of a matrix configured to be used in some other computing process. Each of the encoded sub-blocks 72 within the encoded matrix block 70 includes a plurality of element indices 74.

The one or more processing devices 32 are further configured to compute a plurality of lookup tables 76 that each include a respective plurality of centroid values 78. As discussed in further detail below, the centroid values 78 approximate the centroids of clusters of the initial matrix elements 54 that are used to compute the encoded matrix block 70. The element indices 74 included in the encoded sub-blocks 72 are the indices of specific centroid values 78 within the lookup tables 76.

The one or more processing devices 32 are further configured to compute a table index array 80 including a plurality of table indices 82. The table indices 82 specify respective lookup tables 76 associated with the encoded sub-blocks 72. Accordingly, rather than using a single lookup table 14, as in conventional distribution encoding, the computing system 30 of FIG. 2 utilizes multiple lookup tables 76 that are associated with different encoded sub-blocks 72. The table index array 80 encodes the mapping between the encoded sub-blocks 72 and the lookup tables 76. By using different lookup tables 76 for different encoded sub-blocks 72, the computing system 30 is configured to account for differences in the respective matrix value distributions of different initial sub-blocks 52 of the initial matrix block 50 from which the encoded matrix block 70 is computed.

The table index array 80 maps two or more of the encoded sub-blocks 72 to a shared lookup table 76. Accordingly, when two or more initial sub-blocks 52 of the initial matrix block 50 have similar distributions of initial matrix elements 54, the same lookup table 76 may be used for those initial sub-blocks 52.

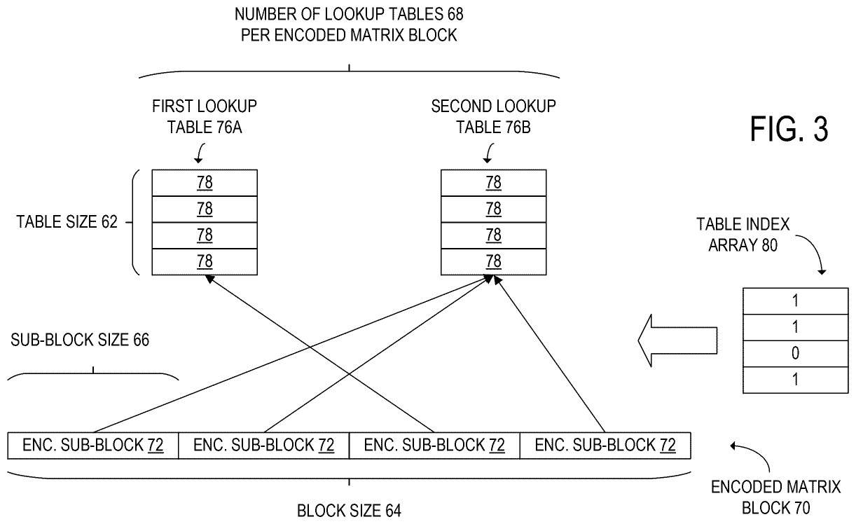

FIG. 3 schematically shows an encoded matrix block 70, a first lookup table 76A, a second lookup table 76B, and a table index array 80, according to one example of multi-table distribution encoding. FIG. 3 further shows the table size 62, block size 64, sub-block size 66, and number of lookup tables 68 that are used to parameterize the computation of the encoded matrix block 70, the lookup tables 76, and the table index array 80 during the encoding stage 40. In the example of FIG. 3, the encoded matrix block 70 is divided into four encoded sub-blocks 72. The table index array 80 maps the first, second, and fourth encoded sub-blocks 72 to the second lookup table 76B and the third encoded sub-block 72 to the first lookup table 76A. This mapping is specified in the table index array 80, in which the first, second, and fourth table indices 82 are equal to 1 and the third table index 82 is equal to 0.

Returning to FIG. 2, during the decoding stage 42, the one or more processing devices 32 are further configured to compute a decoded matrix block 90. The decoded matrix block 90 may, for example, be a decoded weight matrix block 90A or a decoded activation matrix block 90B of a neural network. The decoded matrix block 90 includes a plurality of decoded sub-blocks 92 computed from respective encoded sub-blocks 72 of the encoded matrix block 70. The decoded matrix blocks 90 each include a plurality of the centroid values 78 retrieved from the lookup tables 76. Thus, the centroid values 78 are used to approximate the initial matrix elements 54. This approximation may be more accurate than the approximation obtained using conventional distribution encoding with a single lookup table, as shown in FIGS. 1A-1B, since different initial sub-blocks 52 with different distributions of initial matrix elements 54 may be encoded with different lookup tables 76.

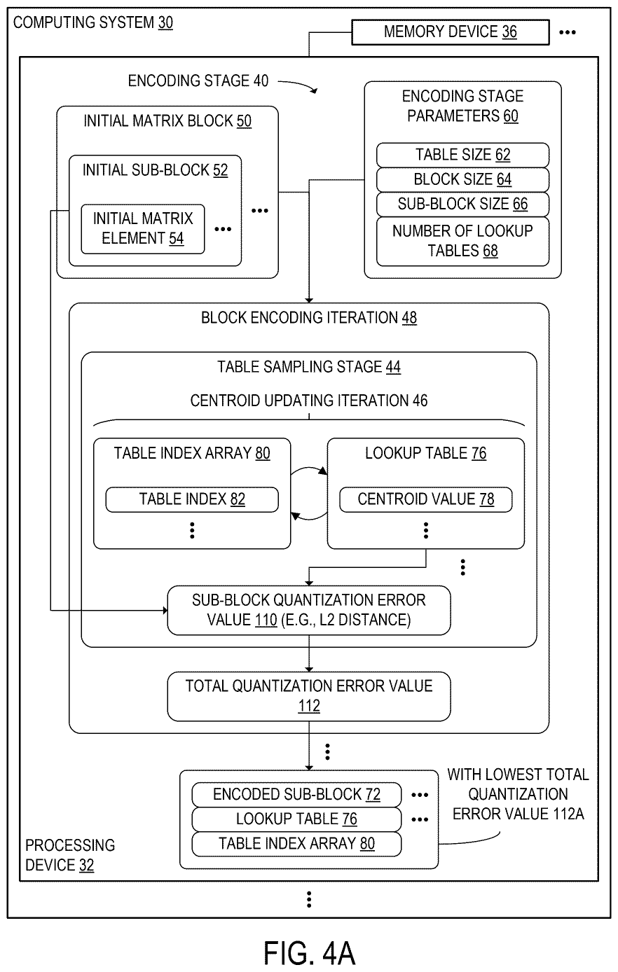

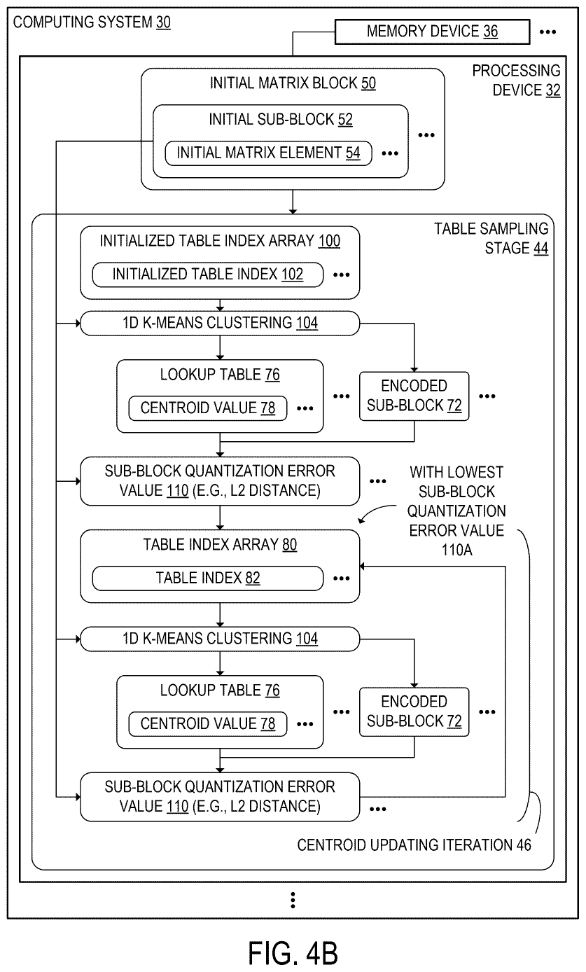

FIGS. 4A-4B schematically show the computing system 30 in additional detail when the encoding stage 40 is performed, according to one example. As shown in FIG. 4A, during the encoding stage 40, the one or more processing devices 32 are configured to compute each of the encoded sub-blocks 72 from a respective initial sub-block 52 of the initial matrix block 50 at least in part by iteratively updating the table indices 82 and the centroid values 78. The encoding stage 40, as shown in the example of FIG. 4A, includes a plurality of block encoding iterations 48 that each include a corresponding table sampling stage 44. Within the table sampling stage 44, the one or more processing devices 32 are configured to perform a plurality of centroid updating iterations 46 that each include updating the table index array 80 and the lookup tables 76. Subsequently to performing the block encoding iterations 48, the one or more processing devices 32 are further configured to output the encoded sub-blocks 72, the lookup table 76, and the table index array 80.

FIG. 4B shows a table sampling stage 44 in additional detail. In each of the table sampling stages 44, the one or more processing devices 32 are configured to randomly or pseudorandomly initialize the respective table indices 82 of each of the initial sub-blocks 52. Thus, the one or more processing devices 32 are configured to compute an initialized table index array 100 that includes a plurality of initialized table indices 102.

Subsequently to computing the initialized table index array 100, the one or more processing devices 32 are further configured to compute the centroid values 78 based at least in part on the initialized table indices 102 and on the plurality of initial matrix elements 54 included in the initial sub-blocks 52. In the example of FIG. 4B, the one or more processing devices 32 are configured to compute the centroid values 78 at least in part by performing one-dimensional (1D) k-means clustering 104 on the plurality of initial matrix elements 54 included in one or more of the initial sub-blocks 52. For each lookup table 76, this 1D k-means clustering 104 may be performed over the set of initial matrix elements 54 included in the one or more initial sub-blocks 52 that the initialized table index array 100 maps to that lookup table 76.

As additional outputs of the 1D k-means clustering 104, the one or more processing devices 32 are further configured to obtain encoded sub-blocks 72 corresponding to the initial sub-blocks 52 that the initial table index array 100 maps to the lookup tables 76. In each of these encoded sub-blocks 72, the element indices 74 are indices of the clusters to which the initial matrix elements 54 included in the initial sub-block 52 are assigned during the 1D k-means clustering 104.

In examples in which 1D k-means clustering 104 is performed, the 1D k-means clustering 104 may return exact centroid values (up to floating-point error) of the k clusters into which the one or more processing devices 32 are configured to group initial matrix elements 54. For example, the one or more processing devices 32 may be configured to execute an exact k-means clustering algorithm that returns the centroid values with the minimum least-squares distances to the points in their corresponding clusters. In one dimension, these exact centroid values may be efficiently computed in polynomial time.

Subsequently to using the initialized table index array 100 to initialize the lookup table 76, the one or more processing devices 32 are further configured to perform one or more centroid updating iterations 46. Each of the centroid updating iterations 46 includes updating the table indices 82 based at least in part on the centroid values 78. For each of the lookup tables 76, the one or more processing devices 32 are configured to perform this update at least in part by computing a sub-block quantization error value 110 between the initial matrix elements 54 included in the corresponding initial sub-block 52 and corresponding closest centroid values 78 included in the lookup table 76. For example, the sub-block quantization error values 110 may be L2 distances. Updating the table indices 82 further includes selecting, as the table index 82 of the initial sub-block 52, the table index 82 of the lookup table 76 with a lowest sub-block quantization error value 110A among the plurality of sub-block quantization error values 110. Accordingly, the one or more processing devices 32 are configured to set the table indices 82 of the initial sub-blocks 52 to the indices of the lookup tables 76 that most closely approximate the matrix element distributions of the initial matrix elements 54 included in those initial sub-blocks 52.

In the example of FIG. 4B, the one or more processing devices 32 are configured to compute a plurality of sub-block quantization error values 110 for the initialized table index array 100 and the lookup tables 76 prior to entering the loop of centroid updating iterations 46, and are further configured to recompute the sub-block quantization error values 110 at the end of each centroid updating iteration 46 after updating the lookup tables 76. The sub-block quantization error values 110 computed at the end of a centroid updating iteration 46 may be used when updating the table index array 80 in a subsequent centroid updating iteration 46.

In each of the centroid updating iterations 46, the one or more processing devices 32 are further configured to recompute the centroid values 78 based at least in part on the table indices 82 and the initial matrix elements 54. As when initially computing the centroid values 78, the one or more processing devices 32 may be configured to recompute the centroid values 78 at least in part by performing 1D k-means clustering 104 on the initial matrix elements 54. For each lookup table 76, the recomputation of the centroid values 78 may be computed over the set of initial matrix elements 54 included in the one or more initial sub-blocks 52 mapped to that lookup table 76 by the table index array 80. The one or more processing devices 32 are further configured to recompute the one or more encoded sub-blocks 72 associated with each lookup table 76 as an additional output of the 1D k-means clustering 104. Thus, the one or more processing devices 32 are configured to update the table index array 80, the lookup tables 76, and the one or more encoded sub-blocks 72 in each of the centroid updating iterations 46.

Returning to FIG. 4A, as discussed above, the one or more processing devices 32 are configured to perform a plurality of block encoding iterations 48. Each of the block encoding iterations 48 includes performing the table sampling stage 44. Subsequently to the table sampling stage 44, each block encoding iteration 48 further includes computing a total quantization error value 112 of the sub-block quantization error values 110 for the encoded sub-blocks 72 with the table indices 82 and the centroid values 78 computed in that table sampling stage 44.

The one or more processing devices 32 are further configured to store the table index array 80 and the lookup tables 76 with which the encoded sub-blocks 72 have a lowest total quantization error value 112A among the total quantization error values 112 computed in the block encoding iterations 48. Accordingly, the one or more processing devices 32 are configured to perform the table sampling stage 44 a predetermined number of times, compute the respective total quantization error values 112 of the encoded sub-blocks 72 computed in those table sampling stages 44, and select the table index array 80 and lookup tables 76 that result in the lowest total quantization error value 112A.

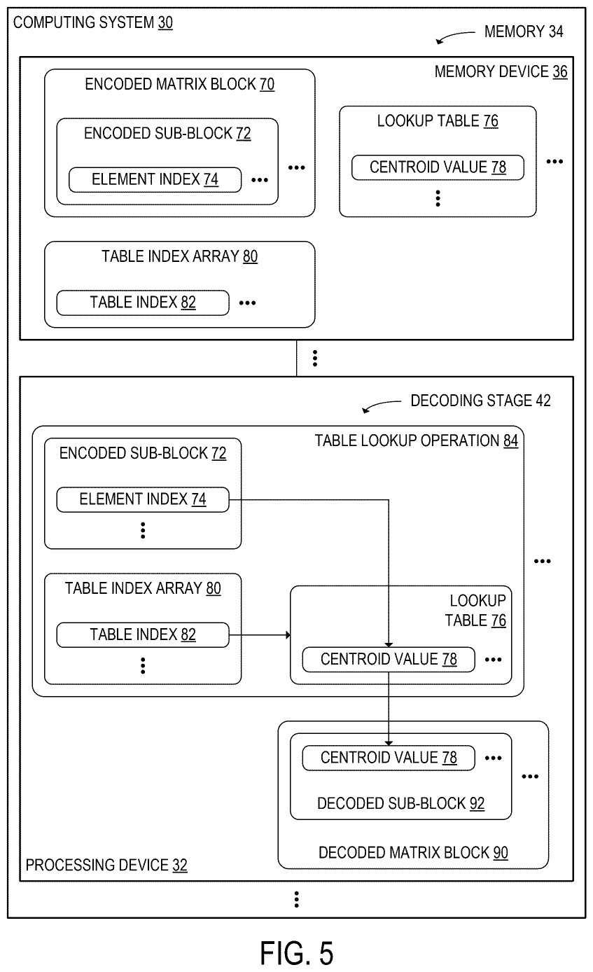

FIG. 5 schematically shows the computing system 30 during the decoding stage 42. In the decoding stage 42, for each of the encoded sub-blocks 72, the one or more processing devices 32 are configured to retrieve the table index 82 of that encoded sub-block 72 from the table index array 80. The one or more processing devices 32 are further configured to retrieve the element indices 74 included in the encoded sub-block 72.

In the decoding stage 42, the one or more processing devices 32 are further configured to perform a plurality of table lookup operations 84 using the table index 82, the lookup table 76, and the element indices 74. In each of these table lookup operations 84, for an element index 74 included in the encoded sub-block 72, the one or more processing devices 32 are configured to retrieve the centroid value 78 specified by the element index 74 from the lookup table 76 specified for the encoded sub-block 72 in the table index array 80. Accordingly, the one or more processing devices 32 are configured to compute a decoded sub-block 92 that includes, for each of the element indices 74 included in the encoded sub-block 72, the corresponding centroid value 78 specified by that element index 74.

The one or more processing devices 32 are configured to compute the decoded matrix block 90 by performing these table lookup operations 84 for each encoded sub-block 72. The one or more processing devices 32 are further configured to output the decoded matrix block 90, including the decoded sub-blocks 92 computed from each of the encoded sub-blocks 72. For example, when the decoded matrix block 90 is a decoded weight matrix block 90A, the one or more processing devices 32 may be configured to store the decoded matrix block 90 in the memory 34 for later use in machine learning model inferencing. In examples in which the decoded matrix block 90 is a decoded activation matrix block 90B, the one or more processing devices 32 may be configured to output the decoded matrix block 90 to a subsequent layer of the neural network.

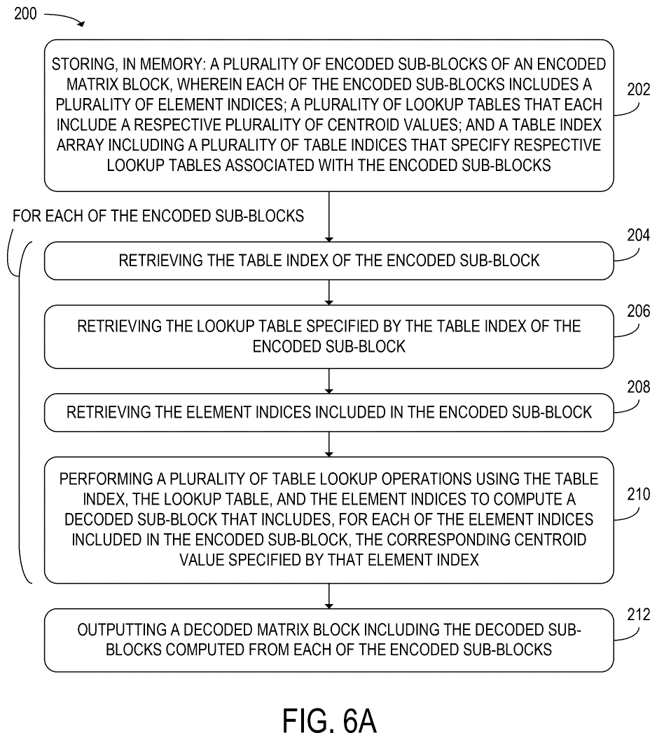

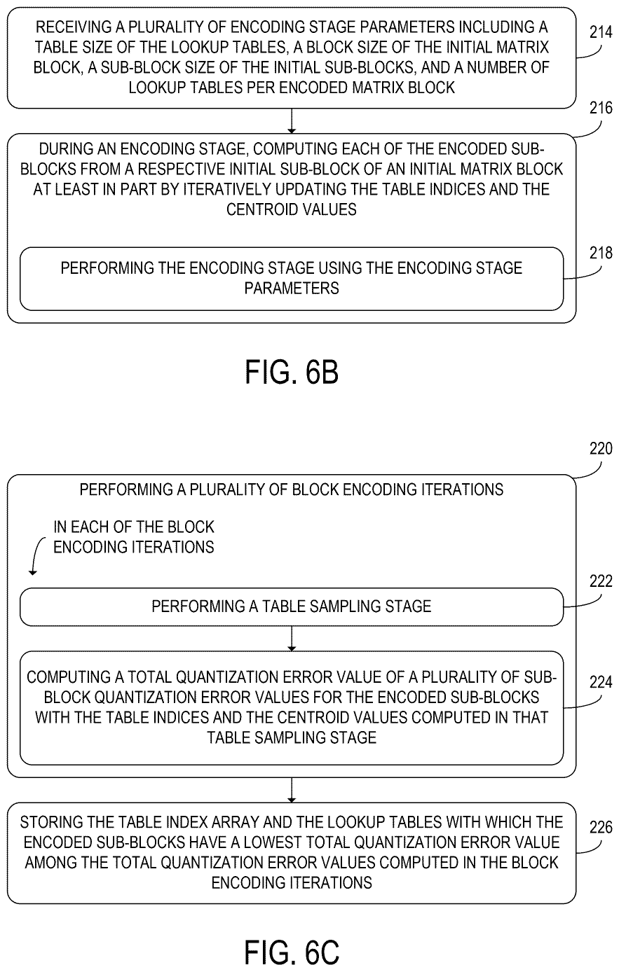

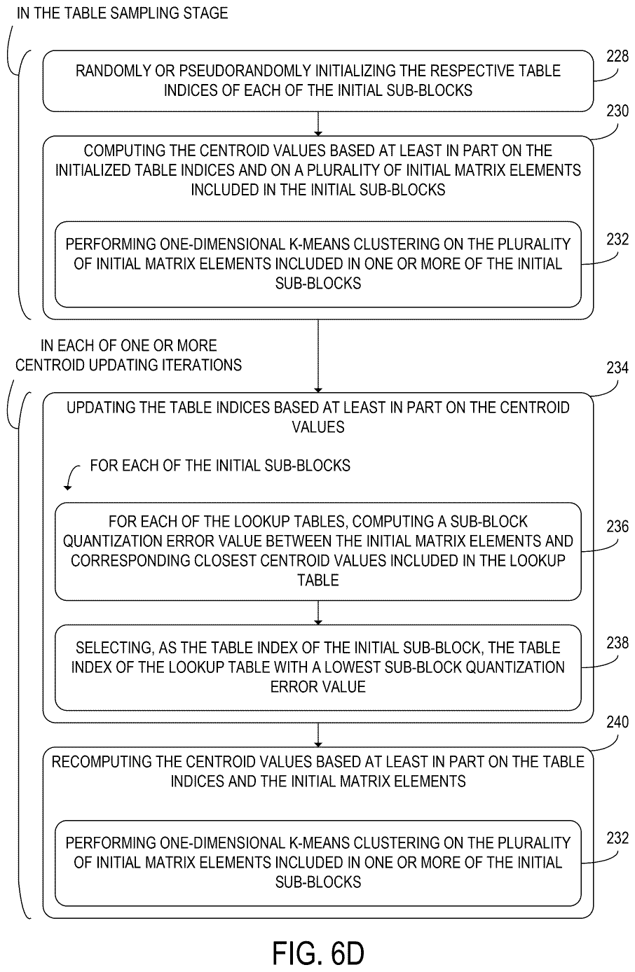

FIG. 6A shows a flowchart of a method 200 for use with a computing system to decode an encoded matrix block that has been encoded with multi-table distribution encoding. At step 202, the method 200 includes storing a plurality of encoded sub-blocks, a plurality of lookup tables, and a table index array in memory. The encoded sub-blocks are included in an encoded matrix block. Each of the encoded sub-blocks includes a plurality of element indices. Thus, the encoded sub-blocks represent respective initial sub-blocks of an initial matrix block in quantized form. The lookup tables each include a respective plurality of centroid values associated with clusters of the initial matrix elements. The table index array includes a plurality of table indices that specify respective lookup tables associated with the encoded sub-blocks. The number of lookup tables is smaller than the number of encoded sub-blocks. Thus, the table index array maps two or more of the encoded sub-blocks to a shared lookup table.

The method 200 includes steps 204, 206, 208, and 210, which are performed during a decoding stage for each of the encoded sub-blocks. At step 204, the method 200 further includes retrieving the table index of the encoded sub-block from the memory. At step 206, the method 200 further includes retrieving the lookup table specified by the table index of the encoded sub-block. At step 208, the method 200 further includes retrieving the element indices included in the encoded sub-block.

At step 210, the method 200 further includes performing a plurality of table lookup operations using the table index, the lookup table, and the element indices to compute a decoded sub-block. The decoded sub-block includes, for each of the element indices included in the encoded sub-block, the corresponding centroid value specified by that element index. Thus, the element indices are converted into estimates of the initial matrix elements by mapping the element indices to the centroid values of the clusters to which those initial matrix elements belong.

At step 212, the method 200 further includes outputting a decoded matrix block including the decoded sub-blocks computed from each of the encoded sub-blocks. For example, the decoded matrix block may be used as an input during machine learning model training or inferencing.

FIGS. 6B-6D shows steps of the method 200 that may be performed during an encoding stage to obtain the encoded matrix block via multi-table distribution encoding. At step 214, as shown in FIG. 6B, the method 200 may further include receiving a plurality of encoding stage parameters. These encoding stage parameters may include a table size of the lookup tables, a block size of the initial matrix block, a sub-block size of the initial sub-blocks, and a number of lookup tables per encoded matrix block. At step 216, during the encoding stage, the method 200 may further include computing each of the encoded sub-blocks from a respective initial sub-block of the initial matrix block at least in part by iteratively updating the table indices and the centroid values. Step 216 may include, at step 218, performing the encoding stage with the lookup tables, the initial matrix block, and the initial sub-blocks parameterized according to the encoding stage parameters.

FIG. 6C shows additional steps of the method 200 that may be performed during the encoding stage at step 216. At step 220, step 216 may further include performing a plurality of block encoding iterations. Each of the block encoding iterations may further include steps 222 and 224. At step 222, step 220 may further include performing a table sampling stage in which the table indices and the centroid values are computed. At step 224, step 220 may further include computing a total quantization error value of the sub-block quantization error values for the encoded sub-blocks with the table indices and the centroid values computed in that table sampling stage. The total quantization error value may be a sum of the quantization error values computed for the plurality of encoded sub-blocks.

At step 226, step 216 may further include storing the table index array and the lookup tables with which the encoded sub-blocks have a lowest total quantization error value among the total quantization error values computed in the block encoding iterations. Thus, the encoding stage may include sampling a plurality of different sets of table indices and corresponding centroid values in respective block encoding iterations and may further include selecting the resulting table index array and lookup tables with the lowest total quantization error.

FIG. 6D shows additional steps of the method 200 that may be performed during the encoding stage at step 216. Steps 228, 230, and 232 may be performed during the table sampling stage. At step 228, step 216 may further include randomly or pseudorandomly initializing the respective table indices of each of the initial sub-blocks. At step 230, the method 200 may further include computing the centroid values based at least in part on the initialized table indices and on a plurality of initial matrix elements included in the initial sub-blocks. Step 230 may include, at step 232, computing the centroid values at least in part by performing one-dimensional k-means clustering on the plurality of initial matrix elements included in one or more of the initial sub-blocks. Accordingly, the centroid values are computed as centroids of clusters of the initial matrix elements. The indices of the clusters to which the initial matrix elements are assigned may also be used as the element indices included in the one or more encoded sub-blocks computed from the one or more initial sub-blocks.

Steps 234, 236, 238, 240 may be performed in each of one or more centroid updating iterations. At step 234, the method step 216 may further include updating the table indices based at least in part on the centroid values. For each of the initial sub-blocks, updating the table indices may include, at step 236, computing a respective sub-block quantization error value for each of the lookup tables. In such examples, these sub-block quantization error values are computed between the initial matrix elements included in the initial sub-blocks and the corresponding closest centroid values included in the lookup table. The sub-block quantization error values may be L2 distances. At step 238, for each of the initial sub-blocks, step 234 may further include selecting the table index of the lookup table with the lowest sub-block quantization error value as the table index of the initial sub-block. Thus, in each of the centroid updating iterations, the sub-block quantization error values are used to select the table indices of lookup tables that accurately approximate the initial sub-blocks.

At step 240, during each of the one or more centroid updating iterations, step 216 may further include recomputing the centroid values based at least in part on the table indices and the initial matrix elements. Recomputing the centroid values at step 240 may include an additional instance of step 232. Thus, the centroid values may be recomputed by performing 1D k-means clustering on the initial matrix elements included in one or more of the initial sub-blocks. The 1D k-means clustering may be performed on each of the sets of one or more initial sub-blocks associated with each of the lookup tables. Thus, the centroid values may be updated to reflect the current table index mapping.

Using the systems and methods discussed above, matrix block elements such as neural network weights or activations are encoded in a quantized form in which the encoded matrix elements are expressed as indices in lookup tables. In contrast to conventional single-table distribution encoding, multiple different lookup tables are used, along with a table index array that maps encoded sub-blocks to corresponding lookup tables. This multi-table distribution encoding thereby compresses the initial matrix block in a manner that has lower quantization error than would be obtained by using a single lookup table, since the lookup tables associated with the encoded sub-blocks can more accurately reflect the distributions of initial matrix elements within the corresponding initial sub-blocks. This decrease in quantization error is achieved without increasing the number of bits included in each of the element indices.

Single-lookup-table distribution encoding has a bitrate (the average number of bits used to store each encoded matrix element) given by the following expression:

$$t * \frac{k}{b} + ⌈ {log}_{2} ( t ) ⌉$$

In the above expression, b is the block size, t is the lookup table size, k is the number of bits used to represent a single lookup table entry, and ┌⋅┐ is the ceiling function. The first summand is the average number of bits used to store the lookup table, and the second summand is the average number of bits used to store the element indices.

Multi-table distribution encoding, in contrast, has a bitrate given by the following expression:

$$n * t * \frac{k}{b} + \frac{⌈ {log}_{2} ( n ) ⌉}{s} + ⌈ {log}_{2} ( t ) ⌉$$

In the above expression, n is the number of lookup tables per encoded matrix block and s is the sub-block size. The first summand is the average number of bits used to store the lookup tables, the second summand is the average number of bits used to store the table indices, and the third summand is the average number of bits used to store the element indices.

Although the bitrate of multi-table distribution encoding is higher than that of single-table distribution encoding for the same values of t, b, and k, the quantization error reduction achieved using multi-table distribution encoding allows for more space-efficient matrix compression at a given quantization error value. In experiments that compared single-table distribution encoding and multi-table distribution encoding when used to quantize matrix blocks of neural network weights, with the bitrate held approximately constant, multi-table distribution encoding decreased the L2 quantization error by approximately 20-25% compared to single-table distribution encoding. Thus, multi-table distribution encoding can encode an initial matrix block more accurately than single-table distribution encoding without an increased bitrate.

Encoding in this manner also enables efficient search techniques by which the encoded sub-blocks, centroid values, and table index may be computed. The computation of the encoded sub-blocks, the centroid values, and the table index includes multiple steps that may be performed in a manner that makes use of parallel processing. For example, a plurality of block encoding iterations may be performed in parallel. As another example, updates to the table indices of the initial sub-blocks may also be performed in parallel for a plurality of initial sub-blocks. An efficient parallel implementation of k-means clustering may also be used to compute the centroid values. Thus, the encoded sub-blocks may be computed in a highly parallelized manner on a hardware accelerator such as a GPU. This parallelizability may allow the encoding stage to be performed efficiently for large matrices such as those included in large neural networks. The decoding stage is also highly parallelizable, since the decoding stage is performed using a plurality of table lookup operations that may be performed in parallel.

The methods and processes described herein are tied to a computing system of one or more computing devices. In particular, such methods and processes can be implemented as a computer-application program or service, an application-programming interface (API), a library, and/or other computer-program product.

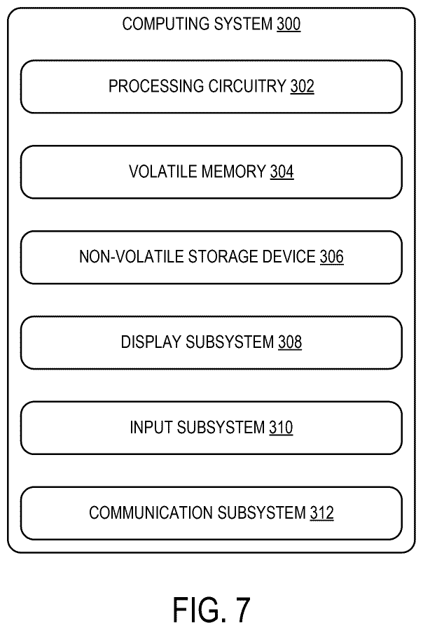

FIG. 7 schematically shows a non-limiting embodiment of a computing system 300 that can enact one or more of the methods and processes described above. Computing system 300 is shown in simplified form. Computing system 300 may instantiate the computing system 30 discussed above with reference to FIG. 2. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including memory storing a plurality of encoded sub-blocks of an encoded matrix block. Each of the encoded sub-blocks includes a plurality of element indices. The memory further stores a plurality of lookup tables that each include a respective plurality of centroid values. The memory further stores a table index array including a plurality of table indices that specify respective lookup tables associated with the encoded sub-blocks. The computing system further includes one or more processing devices configured to, during a decoding stage, for each of the encoded sub-blocks, retrieve the table index of the encoded sub-block, retrieve the lookup table specified by the table index of the encoded sub-block, and retrieve the element indices included in the encoded sub-block. The one or more processing devices are further configured to perform a plurality of table lookup operations using the table index, the lookup table, and the element indices to compute a decoded sub-block that includes, for each of the element indices included in the encoded sub-block, the corresponding centroid value specified by that element index. The one or more processing devices are further configured to output a decoded matrix block including the decoded sub-blocks computed from each of the encoded sub-blocks. The above features may have the technical effect of quantizing a matrix block in a manner that achieves lower quantization error for a given bitrate.

According to this aspect, during an encoding stage, the one or more processing devices may be further configured to compute each of the encoded sub-blocks from a respective initial sub-block of an initial matrix block at least in part by iteratively updating the table indices and the centroid values. The above features may have the technical effect of iteratively computing table indices and centroid values that allow the initial matrix block to be encoded accurately.

According to this aspect, iteratively updating the table indices and the centroid values may include, in a table sampling stage, randomly or pseudorandomly initializing the respective table indices of each of the initial sub-blocks. The table sampling stage may further include computing the centroid values based at least in part on the initialized table indices and on a plurality of initial matrix elements included in the initial sub-blocks. In each of one or more centroid updating iterations, the table sampling stage may further include updating the table indices based at least in part on the centroid values. Each of the one or more centroid updating iterations may further include recomputing the centroid values based at least in part on the table indices and the initial matrix elements. The above features may have the technical effect of initializing and iteratively recomputing the table indices and centroid values.

According to this aspect, during the table sampling stage, the one or more processing devices may be configured to compute the centroid values at least in part by performing one-dimensional k-means clustering on the plurality of initial matrix elements included in one or more of the initial sub-blocks. The above features may have the technical effect of efficiently computing the centroid values.

According to this aspect, during the table sampling stage, the one or more processing devices may be configured to update the table indices at least in part by, for each of the initial sub-blocks, for each of the lookup tables, computing a sub-block quantization error value between the initial matrix elements and corresponding closest centroid values included in the lookup table. Updating the table indices for each of the initial sub-blocks may further include selecting, as the table index of the initial sub-block, the table index of the lookup table with a lowest sub-block quantization error value. The above features may have the technical effect of selecting table indices that result in low quantization error values.

According to this aspect, the one or more processing devices may be further configured to perform a plurality of block encoding iterations that each include performing the table sampling stage. Each of the block encoding iterations may further include computing a total quantization error value of the sub-block quantization error values for the encoded sub-blocks with the table indices and the centroid values computed in that table sampling stage. The one or more processing devices may be further configured to store the table index array and the lookup tables with which the encoded sub-blocks have a lowest total quantization error value among the total quantization error values computed in the block encoding iterations. The above features may have the technical effect of repeating the table sampling stage to obtain table indices and centroid values that result in a low total quantization error value.

According to this aspect, the sub-block quantization error values are L2 distances. The above feature may have the technical effect of efficiently computing the sub-block quantization error values of the encoded sub-blocks.

According to this aspect, the one or more processing devices may be further configured to receive a plurality of encoding stage parameters including a table size of the lookup tables, a block size of the initial matrix block, a sub-block size of the initial sub-blocks, and a number of lookup tables per encoded matrix block. The one or more processing devices may be further configured to perform the encoding stage with the lookup tables, the initial matrix block, and the initial sub-blocks parameterized according to the encoding stage parameters. The above features may have the technical effect of configuring the parameters with which the initial matrix block is encoded.

According to this aspect, the table index array may map two or more of the encoded sub-blocks to a shared lookup table. The above feature may have the technical effect of reducing the computational overhead of encoding initial sub-blocks that have similar distributions of initial matrix elements.

According to this aspect, the encoded matrix block may be an encoded weight matrix block or an encoded activation matrix block of a neural network. The above features may have the technical effect quantizing a weight matrix or activation matrix of the neural network.

According to another aspect of the present disclosure, a method for use with a computing system is provided. The method includes storing, in memory, a plurality of encoded sub-blocks of an encoded matrix block. Each of the encoded sub-blocks includes a plurality of element indices. The method further includes storing, in the memory, a plurality of lookup tables that each include a respective plurality of centroid values, and a table index array including a plurality of table indices that specify respective lookup tables associated with the encoded sub-blocks. During a decoding stage, for each of the encoded sub-blocks, the method further includes retrieving the table index of the encoded sub-block, retrieving the lookup table specified by the table index of the encoded sub-block, and retrieving the element indices included in the encoded sub-block. The method further includes performing a plurality of table lookup operations using the table index, the lookup table, and the element indices to compute a decoded sub-block that includes, for each of the element indices included in the encoded sub-block, the corresponding centroid value specified by that element index. The method further includes outputting a decoded matrix block including the decoded sub-blocks computed from each of the encoded sub-blocks. The above features may have the technical effect of quantizing a matrix block in a manner that achieves lower quantization error for a given bitrate.

According to this aspect, during an encoding stage, the method may further include computing each of the encoded sub-blocks from a respective initial sub-block of an initial matrix block at least in part by iteratively updating the table indices and the centroid values. The above features may have the technical effect of iteratively computing table indices and centroid values that allow the initial matrix block to be encoded accurately.

According to this aspect, iteratively updating the table indices and the centroid values may include, in a table sampling stage, randomly or pseudorandomly initializing the respective table indices of each of the initial sub-blocks. The table sampling stage may further include computing the centroid values based at least in part on the initialized table indices and on a plurality of initial matrix elements included in the initial sub-blocks. In each of one or more centroid updating iterations, the table sampling stage may further include updating the table indices based at least in part on the centroid values and recomputing the centroid values based at least in part on the table indices and the initial matrix elements. The above features may have the technical effect of initializing and iteratively recomputing the table indices and centroid values.

According to this aspect, during the table sampling stage, the method may further include computing the centroid values at least in part by performing one-dimensional k-means clustering on the plurality of initial matrix elements included in one or more of the initial sub-blocks. The above features may have the technical effect of efficiently computing the centroid values.

According to this aspect, during the table sampling stage, the method may further include updating the table indices at least in part by, for each of the initial sub-blocks, for each of the lookup tables, computing a sub-block quantization error value between the initial matrix elements and corresponding closest centroid values included in the lookup table. The method may further include selecting, as the table index of the initial sub-block, the table index of the lookup table with a lowest sub-block quantization error value. The above features may have the technical effect of selecting table indices that result in low quantization error values.

According to this aspect, the method may further include performing a plurality of block encoding iterations that each include performing the table sampling stage. Each of the block encoding iterations may further include computing a total quantization error value of the sub-block quantization error values for the encoded sub-blocks with the table indices and the centroid values computed in that table sampling stage. The method may further include storing the table index array and the lookup tables with which the encoded sub-blocks have a lowest total quantization error value among the total quantization error values computed in the block encoding iterations. The above features may have the technical effect of repeating the table sampling stage to obtain table indices and centroid values that result in a low total quantization error value.

According to this aspect, the sub-block quantization error values may be L2 distances. The above feature may have the technical effect of efficiently computing the sub-block quantization error values of the encoded sub-blocks.

According to this aspect, the method may further include receiving a plurality of encoding stage parameters including a table size of the lookup tables, a block size of the initial matrix block, a sub-block size of the initial sub-blocks, and a number of lookup tables per encoded matrix block. The method may further include performing the encoding stage with the lookup tables, the initial matrix block, and the initial sub-blocks parameterized according to the encoding stage parameters. The above features may have the technical effect of configuring the parameters with which the initial matrix block is encoded.

According to this aspect, the table index array may map two or more of the encoded sub-blocks to a shared lookup table. The above feature may have the technical effect of reducing the computational overhead of encoding initial sub-blocks that have similar distributions of initial matrix elements.

According to another aspect of the present disclosure, a computing system is provided, including one or more processing devices configured to perform multi-table distribution encoding. Performing multi-table distribution encoding includes receiving an initial matrix block including a plurality of initial sub-blocks. The initial sub-blocks each include a plurality of initial matrix elements. Performing multi-table distribution encoding further includes computing an encoded matrix block including a plurality of encoded sub-blocks at least in part by iteratively updating a table index array, a plurality of lookup tables, and the plurality of encoded sub-blocks. The plurality of lookup tables each include a respective plurality of centroid values. Each of the centroid values is computed at least in part by performing one-dimensional k-means clustering on the plurality of initial matrix elements included in the initial sub-blocks. The table index array includes a plurality of table indices that specify respective lookup tables associated with the encoded sub-blocks. The table index array maps two or more of the encoded sub-blocks to a shared lookup table. Each of the encoded sub-blocks includes a plurality of element indices that specify respective centroid values of the plurality of centroid values. Performing multi-table distribution encoding further includes outputting the encoded matrix block, the plurality of lookup tables, and the table index array. The above features may have the technical effect of quantizing a matrix block in a manner that achieves lower quantization error for a given bitrate.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
memory storing:
a plurality of encoded sub-blocks of an encoded matrix block, wherein each of the encoded sub-blocks includes a plurality of element indices;
a plurality of lookup tables that each include a respective plurality of centroid values; and
a table index array including a plurality of table indices that specify respective lookup tables associated with the encoded sub-blocks; and
one or more processing devices configured to, during a decoding stage:
for each of the encoded sub-blocks:
retrieve the table index of the encoded sub-block;
retrieve the lookup table specified by the table index of the encoded sub-block;
retrieve the element indices included in the encoded sub-block; and
perform a plurality of table lookup operations using the table index, the lookup table, and the element indices to compute a decoded sub-block that includes, for each of the element indices included in the encoded sub-block, the corresponding centroid value specified by that element index; and
output a decoded matrix block including the decoded sub-blocks computed from each of the encoded sub-blocks.

2. The computing system of claim 1, wherein, during an encoding stage, the one or more processing devices are further configured to compute each of the encoded sub-blocks from a respective initial sub-block of an initial matrix block at least in part by iteratively updating the table indices and the centroid values.

3. The computing system of claim 2, wherein iteratively updating the table indices and the centroid values includes, in a table sampling stage:
randomly or pseudorandomly initializing the respective table indices of each of the initial sub-blocks;
computing the centroid values based at least in part on the initialized table indices and on a plurality of initial matrix elements included in the initial sub-blocks; and
in each of one or more centroid updating iterations:
updating the table indices based at least in part on the centroid values; and
recomputing the centroid values based at least in part on the table indices and the initial matrix elements.

4. The computing system of claim 3, wherein, during the table sampling stage, the one or more processing devices are configured to compute the centroid values at least in part by performing one-dimensional k-means clustering on the plurality of initial matrix elements included in one or more of the initial sub-blocks.

5. The computing system of claim 3, wherein, during the table sampling stage, the one or more processing devices are configured to update the table indices at least in part by, for each of the initial sub-blocks:
for each of the lookup tables, computing a sub-block quantization error value between the initial matrix elements and corresponding closest centroid values included in the lookup table; and
selecting, as the table index of the initial sub-block, the table index of the lookup table with a lowest sub-block quantization error value.

6. The computing system of claim 5, wherein the one or more processing devices are further configured to:
perform a plurality of block encoding iterations that each include:
performing the table sampling stage; and
computing a total quantization error value of the sub-block quantization error values for the encoded sub-blocks with the table indices and the centroid values computed in that table sampling stage; and
store the table index array and the lookup tables with which the encoded sub-blocks have a lowest total quantization error value among the total quantization error values computed in the block encoding iterations.

7. The computing system of claim 5, wherein the sub-block quantization error values are L2 distances.

8. The computing system of claim 2, wherein the one or more processing devices are further configured to:
receive a plurality of encoding stage parameters including:
a table size of the lookup tables;
a block size of the initial matrix block;
a sub-block size of the initial sub-blocks; and
a number of lookup tables per encoded matrix block; and
perform the encoding stage with the lookup tables, the initial matrix block, and the initial sub-blocks parameterized according to the encoding stage parameters.

9. The computing system of claim 1, wherein the table index array maps two or more of the encoded sub-blocks to a shared lookup table.

10. The computing system of claim 1, wherein the encoded matrix block is an encoded weight matrix block or an encoded activation matrix block of a neural network.

11. A method for use with a computing system, the method comprising:
storing, in memory:
a plurality of encoded sub-blocks of an encoded matrix block, wherein each of the encoded sub-blocks includes a plurality of element indices;
a plurality of lookup tables that each include a respective plurality of centroid values; and
a table index array including a plurality of table indices that specify respective lookup tables associated with the encoded sub-blocks; and
during a decoding stage:
for each of the encoded sub-blocks:
retrieving the table index of the encoded sub-block;
retrieving the lookup table specified by the table index of the encoded sub-block;
retrieving the element indices included in the encoded sub-block; and
performing a plurality of table lookup operations using the table index, the lookup table, and the element indices to compute a decoded sub-block that includes, for each of the element indices included in the encoded sub-block, the corresponding centroid value specified by that element index; and
outputting a decoded matrix block including the decoded sub-blocks computed from each of the encoded sub-blocks.

12. The method of claim 11, further comprising, during an encoding stage, computing each of the encoded sub-blocks from a respective initial sub-block of an initial matrix block at least in part by iteratively updating the table indices and the centroid values.

13. The method of claim 12, wherein iteratively updating the table indices and the centroid values includes, in a table sampling stage:
randomly or pseudorandomly initializing the respective table indices of each of the initial sub-blocks;
computing the centroid values based at least in part on the initialized table indices and on a plurality of initial matrix elements included in the initial sub-blocks; and
in each of one or more centroid updating iterations:
updating the table indices based at least in part on the centroid values; and
recomputing the centroid values based at least in part on the table indices and the initial matrix elements.

14. The method of claim 13, further comprising, during the table sampling stage, computing the centroid values at least in part by performing one-dimensional k-means clustering on the plurality of initial matrix elements included in one or more of the initial sub-blocks.

15. The method of claim 13, further comprising, during the table sampling stage, updating the table indices at least in part by, for each of the initial sub-blocks:
for each of the lookup tables, computing a sub-block quantization error value between the initial matrix elements and corresponding closest centroid values included in the lookup table; and
selecting, as the table index of the initial sub-block, the table index of the lookup table with a lowest sub-block quantization error value.

16. The method of claim 15, further comprising:
performing a plurality of block encoding iterations that each include:
performing the table sampling stage; and
computing a total quantization error value of the sub-block quantization error values for the encoded sub-blocks with the table indices and the centroid values computed in that table sampling stage; and
storing the table index array and the lookup tables with which the encoded sub-blocks have a lowest total quantization error value among the total quantization error values computed in the block encoding iterations.

17. The method of claim 15, wherein the sub-block quantization error values are L2 distances.

18. The method of claim 12, further comprising:
receiving a plurality of encoding stage parameters including:
a table size of the lookup tables;
a block size of the initial matrix block;
a sub-block size of the initial sub-blocks; and
a number of lookup tables per encoded matrix block; and
performing the encoding stage with the lookup tables, the initial matrix block, and the initial sub-blocks parameterized according to the encoding stage parameters.

19. The method of claim 11, wherein the table index array maps two or more of the encoded sub-blocks to a shared lookup table.

20. A computing system comprising:
one or more processing devices configured to perform multi-table distribution encoding at least in part by:
receiving an initial matrix block including a plurality of initial sub-blocks, wherein the initial sub-blocks each include a plurality of initial matrix elements;
computing an encoded matrix block including a plurality of encoded sub-blocks at least in part by iteratively updating a table index array, a plurality of lookup tables, and the plurality of encoded sub-blocks, wherein:
the plurality of lookup tables each include a respective plurality of centroid values;
each of the centroid values is computed at least in part by performing one-dimensional k-means clustering on the plurality of initial matrix elements included in the initial sub-blocks;
the table index array includes a plurality of table indices that specify respective lookup tables associated with the encoded sub-blocks;
the table index array maps two or more of the encoded sub-blocks to a shared lookup table; and
each of the encoded sub-blocks includes a plurality of element indices that specify respective centroid values of the plurality of centroid values; and
outputting the encoded matrix block, the plurality of lookup tables, and the table index array.
